(19) United States
(12) Patent Application Publication
(10) Pub. No.: US 2026/0023941 A1
(43) Pub. Date: Jan. 22, 2026

(54) Analog Computing System For Accelerating Combinatorial Optimization

(71) Applicant: The Regents of The University of Michigan, Ann Arbor, MI (US)

(72) Inventors: Aditya SHUKLA, Ann Arbor, MI (US); Mikhail EREMENTCHOUK, Ann Arbor, MI (US); Pinaki MAZUMDER, Ann Arbor, MI (US)

(73) Assignee: The Regents of The University of Michigan, Ann Arbor, MI (US)

(21) Appl. No.: 18/777,116

(22) Filed: Jul. 18, 2024

(51) Int. Cl. G06J 1/02

(52) U.S. Cl. CPC G06J 1/02

(57) ABSTRACT

A hybrid analog-digital architecture is presented. The hybrid analog-digital architecture is comprised of an adjacency memory, a global controller, an array of memory cells and a computing circuit. The adjacency memory is configured to store a graph representing an optimization problem. The array of memory cells is arranged in columns and rows. Each node of the graph is assigned to a memory cell in the array of memory cells and each memory cell is configured to store an electric charge representing a spin state of an Ising model. The computing circuit is interfaced with the array of memory cells. The computing circuit is configured to read current from a given pair of memory cells in the array of memory cells, compute a differential current between the currents read from the given pair of memory cells, compute an update charge for one of the memory cells in the given pair of memory cells using the differential current, and transfer the update charge to the one memory cell in the given pair of memory cells. The global controller is interconnected between the adjacency memory and the array of memory cells.

### GOVERNMENT CLAUSE

The invention was made with government support under 1710940 awarded by the US National Science Foundation and FA9550-16-1-0363 awarded by the Air Force Office of Scientific Research. The government has certain rights in the invention.

### FIELD

The present disclosure relates to a hybrid analog-digital architecture for solving optimization problems.

### BACKGROUND

Combinatorial optimization finds its application in a vast majority of fields, such as commerce, resource allocation, semiconductor chip-design, and medicine. A large proportion of these problems requires computing resources that exponentially scale with the number of variables, meaning that a solvable problem may become practically unsolvable by just doubling its size. This has motivated (1) specialized algorithms that provide the solution for either simplified problems, or answers with various degrees of approximation, and (2) application-specific accelerators aimed at reducing the time-to-solution for large problems.

Finding the maximum cut of a generic graph, or the max-cut problem, is a well-studied problem in the context of the design of approximate algorithms for NP-hard problems. To tackle a general max-cut problem's exponential complexity, several polynomial-time approximate algorithms exist that guarantee bound on the approximate solution. So far, the algorithms providing the tightest bounds are based on the semidefinite programming (SDP) relaxation. However, these may become impractical for graphs with a large number of vertices as these involve operations on vectors with an equally large number of elements.

The heuristic by Burer, Monteiro and Zhang (henceforth called BMZ heuristic), described in S. Burer, R. D. C. Monteiro, and Y. Zhang, “Rank-Two Relaxation Heuristics for MAX-CUT and Other Binary Quadratic Programs,” SIAM J. Optim., vol. 12, no. 2 (2002), uses rank-2 SDP. Because of the greatly reduced dimensionality, this heuristic is much faster than the rank-N SDP. For max-cut, this heuristic has been shown to be one of the best performing ones. Although the rank-2 SDP is not guaranteed to perform like the full-rank SDP, the BMZ heuristic provides good quality solutions with a more manageable computational resource scaling.

For accelerated solving of combinatorial optimization problems, several dedicated efficient CMOS-based accelerators, simulating Ising (binary) spin-models, have been proposed. While the matrix-vector multiplication heavy annealing algorithms have greatly benefited from hardware-related schemes, acceleration techniques for the BMZ heuristic have been limited. This originates from relatively complex dynamics of the heuristic, which comprises a system of pair-wise non-linearly coupled real variables.

In this disclosure, a fully custom CMOS accelerator is presented for the relaxed rank-2 SDP dynamics. At the algorithm-level, rank-2 SDP dynamics is relaxed from the sinusoidal to triangular coupling, causing the kernel operation to be realizable using analog computing methodologies, with only a slight compromise in the solution quality. Computer architecture-wise, continuous variables are represented by analog voltages while an array of analog vertices supports all-to-all connectivity of graphs, and extends to post-SDP operations. The coupling arithmetic is conducted on a shared arithmetic unit and an accumulation mechanism is used to update the states.

This section provides background information related to the present disclosure which is not necessarily prior art.

### SUMMARY

This section provides a general summary of the disclosure, and is not a comprehensive disclosure of its full scope or all of its features.

A hybrid analog-digital architecture is presented. The hybrid analog-digital architecture is comprised of an adjacency memory, a global controller, an array of memory cells and a computing circuit. The adjacency memory is configured to store a graph representing an optimization problem. The array of memory cells are arranged in columns and rows. Each node of the graph is assigned to a memory cell in the array of memory cells and each memory cell is configured to store an electric charge representing a spin state of an Ising model. The computing circuit is interfaced with the array of memory cells. The computing circuit is configured to read current from a given pair of memory cells in the array of memory cells, compute a differential current between the currents read from the given pair of memory cells, compute an update charge for one of the memory cells in the given pair of memory cells using the differential current, and transfer the update charge to the one memory cell in the given pair of memory cells. The global controller is interconnected between the adjacency memory and the array of memory cells.

Prior to operation, the global controller is configured to initialize spin states of the memory cells in the array of memory cells. During operation, the global controller iteratively updates the electric charge stored in each memory cell of the array of memory cells until a stopping condition is met. To do so, the global controller selects a given pair of memory cells in the array of memory cells in accordance with the graph and coordinates an update to one of the memory cells in the given pair of memory cells using the computing circuit.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B are graphs comparing the Hamiltonian kernel and the dynamic coupling function, respectively, for the rank-2 relaxation to the triangular model.

FIG. 2A depicts an example graph with twenty-five vertices.

FIG. 2B is a graph showing state evolution based on the relaxed dynamics with period of ϕ set to 2, for 50 time steps.

FIGS. 2C and 2D are polar plots of the states at T=0 and T=50, respectively.

FIGS. 2E and 2F are graphs showing cut versus polar angle at T =0 and T=50, respectively, with the dashed line indicating the max-cut.

FIG. 2G is a graph showing the average cut evolution from 20 random initial conditions as obtained using the relaxed heuristic and the local search procedure.

FIG. 3A is a diagram illustrating evaluating modulo for computing ϕ(vᵢ−vᵢ) on a 3×3 vertex array.

FIG. 3B is a diagram illustrating temporally multiplexed multiply-accumulate on a 3×3 vertex array.

FIG. 4 is a block diagram of a hybrid analog-digital architecture.

FIG. 5 is a diagram depicting an example embodiment for the array of memory cells.

FIG. 6 is a block diagram depicting a memory cell in the array of memory cells.

FIG. 7 depicts an example implementation of the computing circuit.

FIG. 8 is a schematic for an example implementation of a memory cell.

FIG. 9 is a flow diagram showing the operation of the global controller.

FIG. 10 is a schematic of a read-write amplifier.

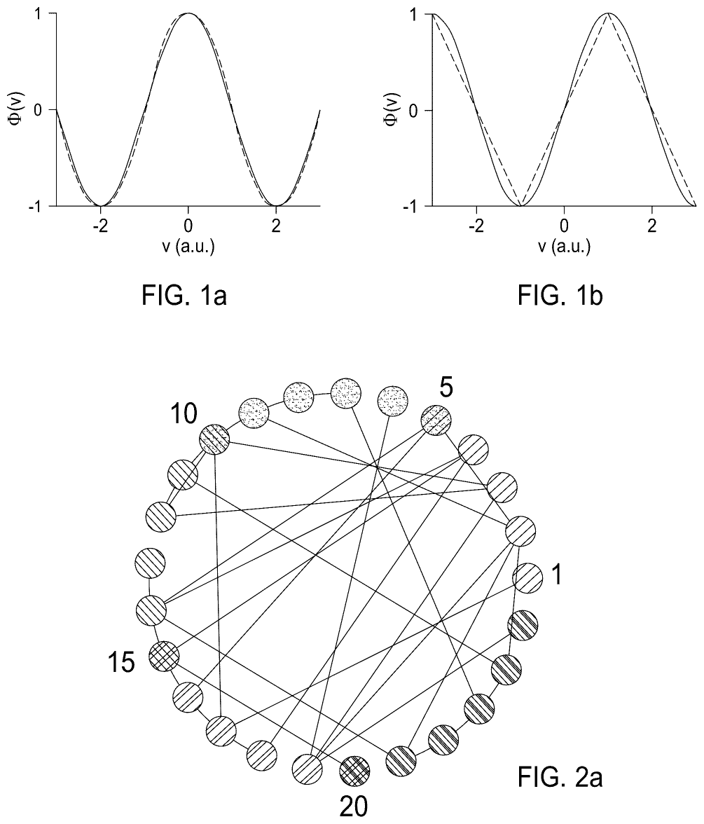

Corresponding reference numerals indicate corresponding parts throughout the several views of the drawings.

### DETAILED DESCRIPTION

Example embodiments will now be described more fully with reference to the accompanying drawings.

Ising model is a set of coupled binary variables (commonly represented by ±1) or spins (symbolically by ↑↓). Each spin is coupled to a subset of other spins which makes one spins-state more energetically favorable than the other. Let the coupling between the spins of Ising model be represented by an undirected graph G with N vertices, M edges and adjacency matrix A={Aᵢⱼ}. For spin-state σ={σᵢi} with σ∈{−1, +1}, the corresponding Hamiltonian H is

$$H ( σ ) = \frac{1}{2} {\sum }_{i , j} {A}_{ij} {σ}_{i} {σ}_{j} \qquad ( 1 )$$

The ground state of the Ising model is the spin-state yielding the minimum value of H(σ).

For generic graphs, finding the ground state is an NP-complete problem. For example, all of Karp's NP-complete problems, described by R. M. Karp in “Reducibility among Combinatorial Problems” published in “Complexity of Computer Computations” (Springer, 1972), can be re-formulated as the ground state search problem of a specially constructed Ising models.

Finding the ground state of the Ising model based on G is equivalent to determining the max-cut of G. Indeed, any spin-state partitions the vertices into two sub-sets: one with only positive spins and another with only negative spins. The corresponding cut-size is defined as the number (or the net weight) of the edges from one partition to the other:

$$\begin{matrix}{χ}_{1} ( σ ) = \frac{1}{4} {\sum }_{i , j} {A}_{ij} ( 1 - {σ}_{i} {σ}_{j} ) \\ = \frac{M}{2} - \frac{1}{2} H ( σ )\end{matrix} \qquad ( 2 )$$

Thus, the minimum of H(σ) corresponds to the maximum of χ_{1(σ)} and vice-versa. Alternatively, the max-cut problem can be presented in terms of a N×N positive semi-definite matrix S:

$${C}_{G} = {max}_{s} \frac{M}{2} - \frac{1}{4} ( A \cdot S ) \qquad ( 3 )$$

$$Subject to rank ( S ) = 1$$

$$diag ( S ) = {\{ 1 \}}^{N}$$

$$S \geq 0$$

where A·S=Σ_{i,j}AᵢⱼSᵢⱼ and the last condition denotes positive semi-definiteness. The spin-state σ and the positive semidefinite matrix S are related by S=σσ^{τ}.

The NP-hardness of the max-cut problem prompted the development of algorithms that guarantee a lower-bound on their approximate solution in polynomial time. Among these, the algorithm described by Goemans and Williamson in “Improved Approximation Algorithm for Maximum Cut and Satisfiability Problems using Semidefinite Programming” Journal ACM, vol. 42, no. 6 (November 1995) provides the tightest bound on the expected solution. Their algorithm has two stages. The first stage replaces each of the N spins, σᵢ, with N-dimensional unit vector \vec{s}ᵢ and the product of spins with their dot-product. Then, an analogue of the cut χₙ is defined

$${χ}_{n} ( \vec{s} ) = \frac{1}{4} {\sum }_{i , j} {A}_{ij} ( 1 - {\vec{s}}_{i} \cdot {\vec{s}}_{j} ) \qquad ( 4 )$$

For S={\vec{s}ᵢ·\vec{s}ₗ}, the following rank-N SDP is solved:

$${C}_{G} = arg {max}_{s} \frac{M}{2} - \frac{1}{4} ( A \cdot S ) \qquad ( 5 )$$

$$Subject to diag ( S ) = {\{ 1 \}}^{N}$$

$$S \geq 0$$

The solution vectors of the SDP problem (\vec{s}ₗ), distributed over the N-dimensional unit sphere, are mapped to +1 or −1 by comparing their orientation with respect to a random hyperplane through the origin. The cut so obtained was shown to be within 87% of the maximum cut for random graphs with non-negative weights.

Burer-Monteiro-Zhang heuristic uses rank-2 SDP, which is equivalent to limiting the dimensionality of \vec{s} to two in equation (4). Each two-dimensional unit vector is represented by polar coordinate θ, so that \vec{s}=[cos(θ), sin(θ)]. The rank-2 cut analogue χ₂ is defined as

$${χ}_{2} ( θ ) = \frac{1}{4} {\sum }_{i , j} {A}_{ij} ( 1 - cos ( {θ}_{i} - {θ}_{j} ) ) , \qquad ( 6 )$$

where θ={θ₁, θ₂, . . . , θₙ}. This heuristic was implemented in the max-cut solver circuit, where the dynamical realization of rank-2 SDP was followed by finding the optimal rounding and post-processing based on 1-opt and 2-opt local search.

The dynamical realization of SDP ensures that χ₂(θ) monotonously increases with time. By updating θ according to dθ/dt=∇χ₂(θ), the equations of motion governing the gradient descent of the system are:

$$\frac{d {θ}_{i}}{dt} = {\sum }_{j} {A}_{ij} sin ( {θ}_{i} - {θ}_{j} ) . \qquad ( 7 )$$

It can be shown that if the stable steady state θ is such that θᵢ−θⱼ=kᵢⱼπ, where kᵢⱼ is an integer, then θ represents the maximum cut. However, generally the elements of θ are distributed across [0, 2π), and consequently each θᵢ (now one-dimensional) is rounded by comparing its orientation with a reference coordinate. Specifically, the following equation may be used to round θ to σ:

$$σ ( {θ}_{Y} ) = sgn ( sin ( θ - {θ}_{Y} ) ) , \qquad ( 8 )$$

where θ_{y} is the reference coordinate. In practice, several θ_{y} are chosen from the range [0, 2π). For each σ(θ_{y}), the corresponding cut is evaluated using equation (2). The configuration leading to the largest cut is selected as the solution of rounding. During post-processing, a local search for the maximal cut is performed, ensuring that the cut cannot be increased by inverting any single spin or a pair of spins.

In contrast with the Goemans and Williamson's rank-N algorithm, rank-2 SDP-based heuristic does not have proven approximation guarantee. The landscape described by χ_{2(θ)} is non-convex and the solution's quality depends on the quality of the minima of the Hamiltonian. Nevertheless, the algorithm was empirically shown to obtain competitive results in polynomial time.

The dynamical rank-2 SDP of the BMZ heuristic can be viewed as a system of vertices with sinusoidal coupling: each vertex i has a dynamical state θᵢ, whose change rate depends non-linearly on states of the other vertices. An exact realization of the nodal coupling dynamics requires computing sinusoidal function over multiple periods. Since there is a separate sine-evaluation corresponding to each edge, this computational effort may greatly shoot up for large and/or dense graphs. Instead, we consider a triangular coupling function, as a simpler piece-wise linear approximation of the sine. This reduces a complex non-linear coupling function to one composed of basic arithmetic operations—pair-wise additions and sign inversions, which are directly realizable using analog computing methods.

In equation (6), if the cosine cut-counting function is replaced with a more general but periodic Φ and the state vector by v, then the new cut χ_{ΦF} is,

$${χ}_{Φ} ( v ) = \frac{1}{4} {\sum }_{i , j} {A}_{ij} ( 1 - Φ ( {v}_{i} - {v}_{j} ) ) , \qquad ( 9 )$$

and correspondingly, the new dynamical equations are

$$\frac{{dv}_{i}}{dt} = {\sum }_{j} {A}_{ij} ϕ ( {v}_{i} - {v}_{j} ) , \qquad ( 10 )$$

where ϕ(v)=−1/2 dΦ(v)/dv. For a piece-wise linear coupling function, Φ is a periodic function with period P and Φ(kP/2)=(−1)^{k}:

$$Φ ( v ) = \{ \begin{matrix}1 - {v}^{2} , & v ∈ ( - \frac{P}{4} , \frac{P}{4} ] \\ {( \vert v \vert - \frac{P}{2} )}^{2} - 1 , & \vert v \vert ∈ ( \frac{P}{4} , \frac{P}{2} ]\end{matrix} \qquad ( 11 )$$

So that

$$ϕ ( v ) = \{ \begin{matrix}- v , & v ∈ ( - \frac{P}{4} , \frac{P}{4} ] \\ v - \frac{P}{2} , & \vert v \vert ∈ ( \frac{P}{4} , \frac{3 P}{4} ]\end{matrix} \qquad ( 12 )$$

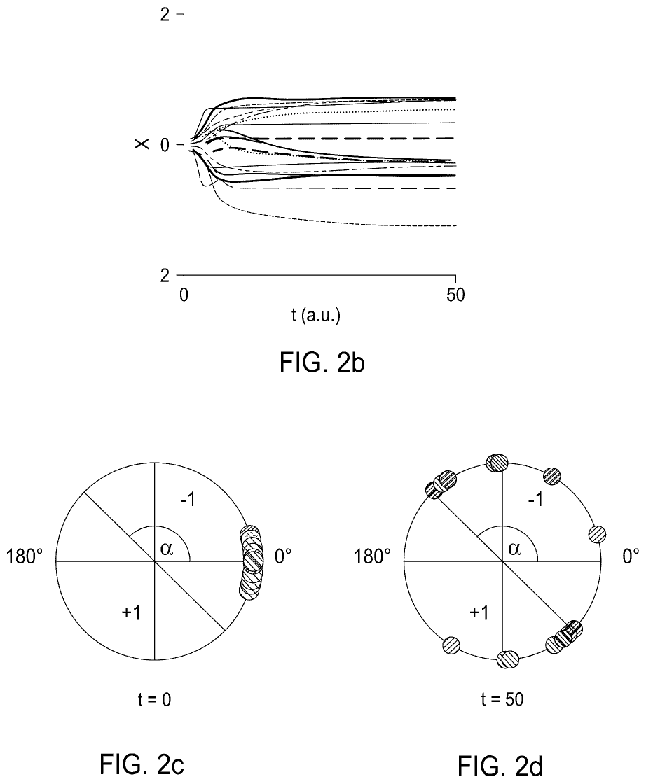

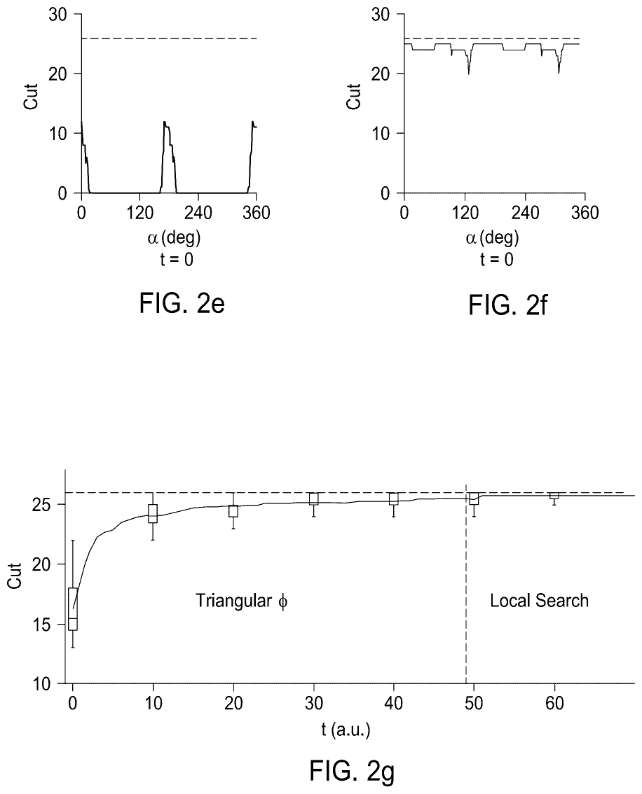

FIGS. 2A and 2B compare Φ and ϕ with the original ones for P=4(a.u.).

The questions regarding the capability of the described heuristics to approximately solve the intended problem in polynomial time were addressed in A. Shukla, M. Erementchouk, and P. Mazumder, “Scalable almost-linear dynamical Ising machines,” Natural Computing (2024) which is incorporated in its entirety by reference herein. The integrality gap due to the random rounding following the new dynamics was shown to be about 85%, versus 87% for the full rank SDP.

The detailed steps of the proposed heuristic are provided in Algorithms 1 and 2.

Algorithm 1: Nodal Coupling Dynamics (Input: A; Output: x).

| 1: | for i ∈ {1, 2. . .N} do | |
|---|---|---|
| 2: | xᵢ ←N(0, γP) | [symbol] Normally distributed |
| 3: | end for | |
| 4: | while t < Tₘₐₓ do | |
| 5: | for i ∈ {1, 2. . .N} do | |
| 6: | S ← ΣⱼA_{i,j}ϕ(xᵢ − xⱼ) | |
| 7: | xᵢ(t + 1) ← xᵢ(t) + ηS | [symbol] η is time-discretization factor |

| | |
|---|---|
| 8: | end for |
| 9: | t ← t + 1 |
| 10: | end while |

In Algorithm 1, the N analog spins are first initialized to normally distributed values after which the states are let to evolve for Tₘₐₓ time-steps.

Algorithm 2: Randomized Rounding (Input: x, K; Output: σ).

1: for i ∈ {1, 2 . . . K} do
2: yᵢ ← ∪ (−P/2, P/2)
3: end for
4: Cₘₐₓ ← 0
5: yₘₐₓ ← y₁
6: for i ∈ {1, 2 . . . K} do
7: for j ∈ {1, 2 . . . N} do
8: σⱼ ← sgn(ϕ(xⱼ − yᵢ))
9: end for
$10 : C ← \frac{M}{2} - {Σ}_{m} {Σ}_{n} {A}_{m , n} \frac{{σ}_{m} {σ}_{n}}{4}$
11: if C > Cₘₐₓ then
12: Cₘₐₓ ← C
13: yₘₐₓ ← yᵢ
14: end if
15: for j ∈{1, 2 . . . N} do
16: σⱼ ← sgn(φ(xⱼ − yₘₐₓ))
17: end for
18: end for

In Algorithm 2, K uniformly distributed rounding centers are chosen. For each choice, the analog spins are rounded to ±1 and the cut evaluated. The algorithm then finds the largest cut and corresponding spin-state.

The heuristic is demonstrated on an example graph with 25 vertices as shown in FIG. 2A. FIG. 2B plots the states of vertices as they evolve following equation (10) with the period of ϕ set to 2. FIGS. 2C and 2D plot the initial and final states as phasors with period of 2. The solid black diameter at angle a rounds continuous states to binary spins, ±1. The mapping clearly depends on α and this dependence is plotted in FIGS. 2E and 2F for the initial and final states. FIG. 2G shows the cut evolution over time. It is divided into two stages: the first shows a coarse optimization from the relaxed heuristics and the second shows a finer increment in the cut from the local search procedure.

Significant progress has been made towards accelerating the ground-state search problem of Ising models and more generally, solving combinatorial optimization problems via dynamical Ising-like models. Binary Ising machines, in most cases, are designed to parallelize the thermal annealing of a large number of semi-independent Ising models. Most binary spin annealing systems are directly challenged by the need for extremely large samples of the spin-states. On the other hand, analog models are hard to implement in a continuous time fashion due to sensitivity to analog parameters, difficulty in replicating their complex dynamics exactly using analog components, and dependence on alternatives to the widely-used CMOS devices.

The polynomial scaling and an overall reduced run-time of the heuristic based on the triangular approximation described above was demonstrated on a general-purpose computer. There, the max-cut values for graphs in G-set, a special benchmarking collection of graphs, were found to be only slightly (about 2%) reduced than the max-cut obtained by solver Circut based on the BMZ heuristic. With the higher level of customization, one expects better scaling performance than achievable by a general-purpose computer.

TABLE I
summarizes the key computational operations in the
algorithm presented above and identifies the corresponding
input and output types.

| | | Algebraic | Input | Output |
|---|---|---|---|---|
| | | expression | type | type |
| Nodal coupling dynamics | | ΣⱼAᵢⱼϕ(xᵢ − xⱼ) | [symbol] ^{N} | [symbol] ^{N} |
| Binarization | Thresholding | sgn(ϕ(xᵢ − xⱼ)) | | {0,1}^{N} |
| | Cut evaluation | ${\sum }_{i , j} {σ}_{i} {A}_{i j} {σ}_{j}$ | {0,1}^{N} | |

The table reveals two key composite operations that need to be efficiently conducted by an accelerator. The first operation is the modulo, defined for any real numbers a and b (b≠0) as mod (a, b)=a−|b|a/|b|, where |x| is the largest integer less than, or equal to x. The function ϕ in equation (12) may be expressed as the modulo with respect to ϕ's period P, followed by conditional sign-inversions. Binarization of analog spins requires a modulo of the analog state with respect to P, followed by 1-bit quantization.

The second operation is multiplication-and-accumulation (MAC). Both cut-evaluation and local search steps involve the product of spin-vector with the adjacency matrix. The vector output determines a binary spin vector either for the binarization or for Hamiltonian reducing spin-flips.

In this disclosure, operations discussed above are based around a mix of analog-digital computing methodologies for two reasons. First, MAC is efficiently accelerated through a simultaneous multi-element product and sum, where the sub-operations of the MAC (usually a product of time-variant vector with time in variant ones) are spatially unfolded and simultaneously conducted. Each analog/digital variable input of the MAC supplies a proportional current signal onto an accumulating wire/bus and thus physical movement of data is avoided. Higher the number of simultaneous summations, more efficient is the accumulation operation via unfolding.

Second, the utlized heuristic based on the triangular approximation involves the evolution of analog variables via a series of accumulations conducted over time. Charge, as an analog variable, can be stored and naturally accumulated on a capacitor, within the limits of supply voltage and leakage. Hence a capacitor can serve as a stationary analog memory element to store the spin-state. Whereas, in a purely digital memory, updating states without the movement of data would require adders in each vertex

FIG. 4 depicts a hybrid analog-digital architecture 40 for solving an optimization problem in accordance with this disclosure. The architecture is comprised of an adjacency memory 41, a global controller 42, an array of memory cells 43, and a computing circuit 44. The adjacency memory 41 is configured to store a graph representing the optimization problem and the final solution to the problem. In one embodiment, the adjacency memory 41 is a non-transitory storage medium. The global controller 42 is interconnected between the adjacency memory 41 and the array of memory cells 43. The global controller controls the time progression for updating the spin-representing variables stored in the array of memory cells 43.

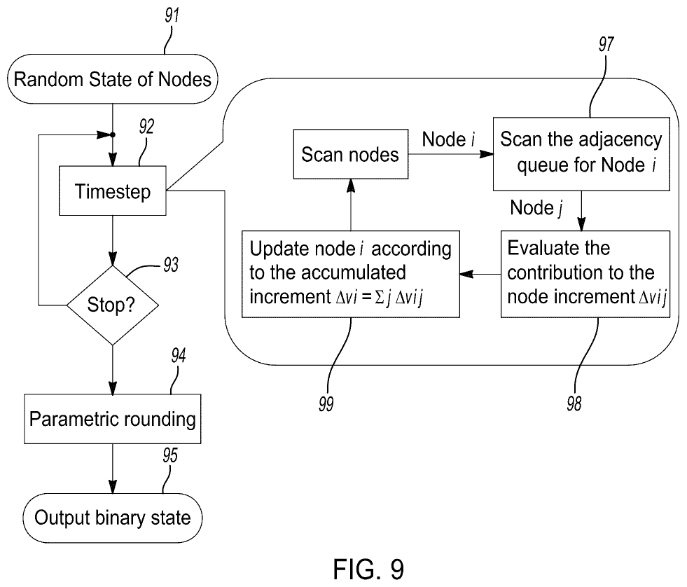

An iterative process for updating the electric charge in each memory cell is further described in relation to FIG. 9. As a starting point, the global controller 42 is configured to initialize spin states of the memory cells in the array of memory cells 43. In one embodiment, the spin state for each memory cell is randomly assigned.

Next, the global controller 42 iteratively updates the electric charge stored in each memory cell of the array of memory cells 43 at 92 until a stopping condition is met as indicated at 93. To do so, the global controller 42 traverses the node in the graph and updates the electric charge associated with a given node in the graph. For a given node in the graph, nodes adjacent to a given node in the graph are identified at 97. For nodes adjacent to the given node, a contribution to the given node by the adjacent node is determined at 98 and then the contributions for the given node are accumulated. Lastly, the electric charge for the given memory cell is updated at 99 with the accumulated contribution, where the given node is assigned to the given memory cell. This process is repeated as each node in the graph is traversed and until the stopping condition is met.

When the stopping criterion is met, the global controller ceases updating the electric charge in the memory cells. In this instance, the electric charges are continuously distributed. To obtain the distribution of binary spins from the terminal state of the memory, the continuously distributed charges must be rounded following the parametric rounding procedure as indicated at 94. The parameter of this procedure is the referential charge stored in a dedicated memory cell. In one embodiment, the value of the referential charge is chosen randomly.

The parametric rounding procedure follows the modified charge updating without performing the charge update step. After the referential charge is set, the global controller iteratively accesses each memory cell of the array. The global controller connects each chosen cell representing a node in a graph with the dedicated memory cell containing the referential charge. The computing circuit evaluates the update charge due to the established connection. If the update charge is zero or positive, the rounded value of the charge stored in the chosen memory cell is taken to be +1, and if the update charge is negative, the rounded value is taken to be −1. Such obtained rounded value is written in the part of the adjacency memory allocated to store the solution of the optimization problem. Finally, the obtained update charge is discarded to keep the charge in the chosen memory cell unchanged.

After the global controller finishes processing the last memory cell, the allocated part of the adjacency memory contains the obtained solution of the optimization problem. In one embodiment, the obtained solution is further processed to evaluate the value of the cut. The parametric rounding procedure is repeated with a newly generated value of the referential charge. Only the rounded solution providing the largest cut value is kept and is output at 95 as the final result produced by the architecture.

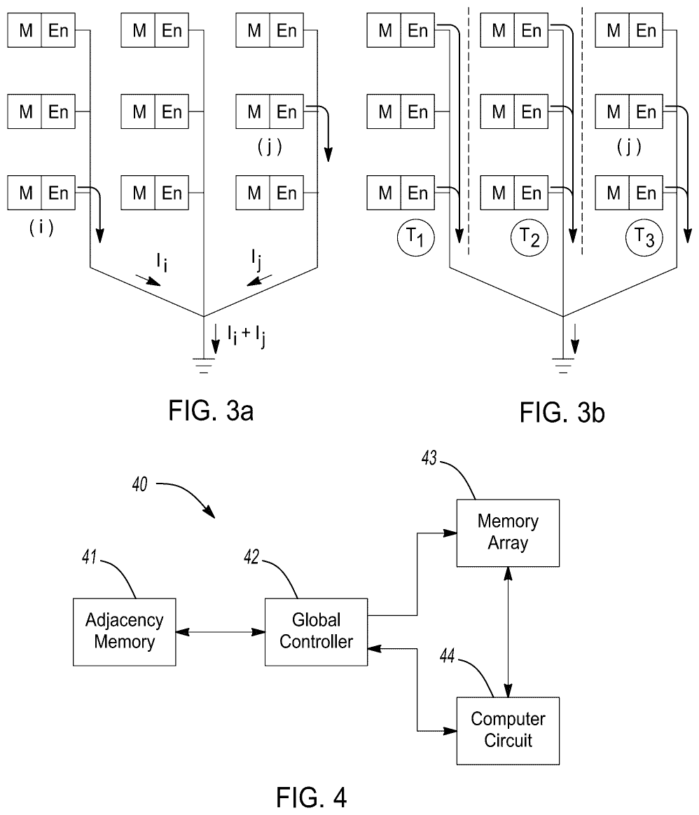

A shared current-bus enables a multi-vertex read via superposition of individual currents and establishes connection with the computing circuit 44. FIG. 3A depicts the modulo operation on a pair of vertices i and j selected from array of vertices. FIG. 4B shows the time-multiplexed MAC operation, divided into multiple column-wise simpler accumulations due to restrictions on the selectability of the vertices.

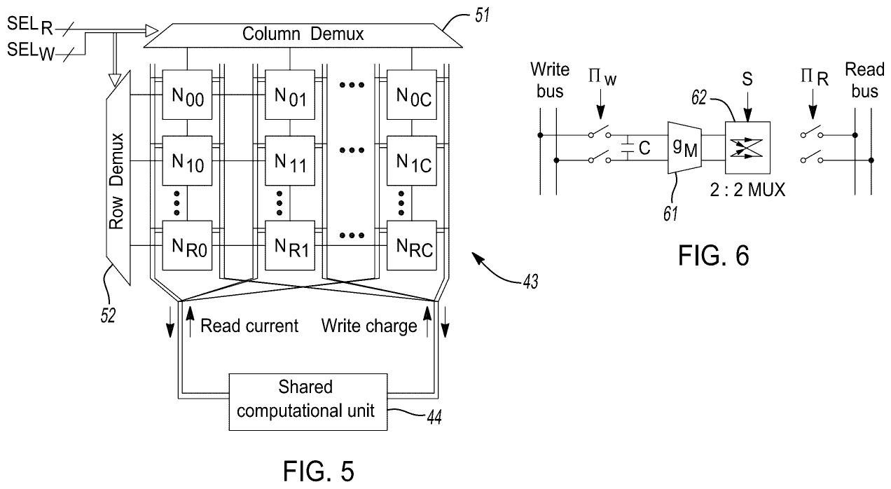

FIG. 5 further depicts an example embodiment for the array of memory cells 43. In this example, an array of memory cells 43 arranged in columns and rows. Each node of the graph is assigned to a memory cell in the array of memory cells. That is, there is a one-to-one correspondence between each node in the graph and a memory cell in the array. Each memory cell is configured to store an electric charge representing a spin state of an Ising model.

An example implementation for a memory cell in the array of memory cells is shown in FIG. 6. In this example, each memory cell in the array of memory cells is comprised of a transconductance cell 61 and a 2:2 multiplexer (i.e., current inverter) 62. Other types of implementations for the memory cells are contemplated by this disclosure.

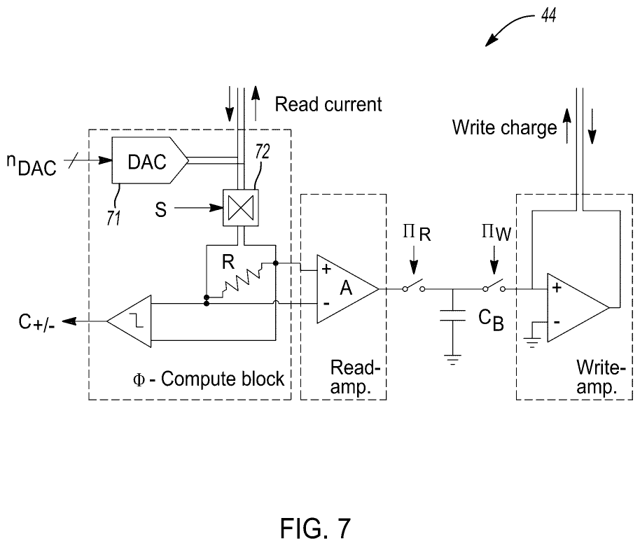

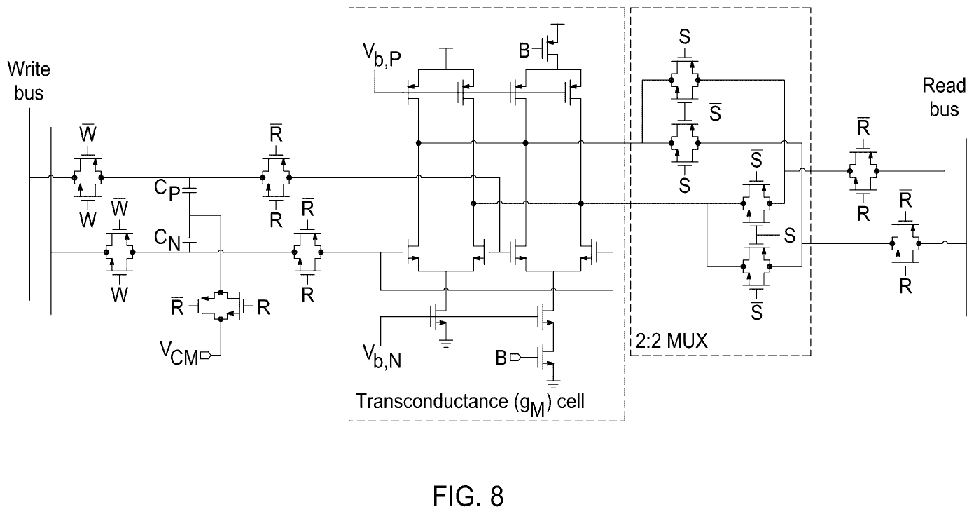

FIG. 7 further depicts an example embodiment of the computing circuit 44. The computing circuit 44 is interfaced with the array of memory cells. The computing circuit 44 is configured to read current from a given pair of memory cells in the array of memory cells, compute a differential current between the currents read from the given pair of memory cells, compute an update charge for one of the memory cells in the given pair of memory cells using the differential current, and transfer the update charge to the one memory cell in the given pair of memory cells.

The entire system of equations in (10) is realized by processing one vertex, one edge at a time. Each such processing is essentially divided into two phases: reading and writing. During the reading phase, given and adjacent vertices are simultaneously read by superposing multiple read currents onto a voltage-pinned current carrying bus. The net current is stepped up/down by superposing digitized current from a digital-to-analog converter (DAC) 71 as seen in FIG. 7. This is followed by sign-inversions from a 2-input and 2-output (2:2) multiplexer 72, to get a current proportional to ϕ. During the writing phase, a voltage proportional to ϕ is buffered onto capacitor C_{B}. The charge so stored is sent up to the updated vertex, through a separate write-bus, leading to the evolution of the state by long-term accumulation.

Considering the array of memory cells (i.e., vertices or nodes of the graph) in FIG. 5, let vertex i be chosen for updating, based on an adjacent vertex j. It is updated by first selecting the vertices via the row and column selection multiplexers 51, 52 and closing the read-switch R or asserting binary signal Π_{R}, while keeping the common-mode bus voltage pinned. This gives an output differential current through the read bus equal to

$${I}_{i} - {I}_{j} = {g}_{M} ( {v}_{c , i} - {v}_{c , j} ) \qquad ( 13 )$$

The sign of differential current Iⱼ above is reversed using 2:2 multiplexer local to the vertex, which reverses the current direction by exchanging the differential components. If the DAC output is represented by nDAcI₀, then it is adjusted so that the net current lies within the peak values of ϕ:

$$- \frac{{I}_{0}}{2} < {I}_{i} - {I}_{j} - {n}_{DAc} {I}_{0} < \frac{{I}_{0}}{2} . \qquad ( 14 )$$

Finally, the input to the multiplexer S is set to nDAC to give a net modulated current

$$ϕ ( {v}_{i} - {v}_{j} ) = {( - 1 )}^{{n}_{DAC}} ( {g}_{M} ( {v}_{i} - {v}_{j} ) - {n}_{DAC} {I}_{0} ) \qquad ( 15 )$$

For writing, once binary signal Π_{w} is asserted, the voltage on the read-bus stored in C_{B} is pushed to the vertex being updated, akin to the standard switched-capacitor accumulator. The change in v_{c,i} is given by

$$δ {v}_{c , i} = \frac{{c}_{B}}{c} AR ϕ ( {v}_{c , i} - {v}_{c , j} ) , \qquad ( 16 )$$

where C is the vertex's capacitance, A is the voltage gain from read current to C_{B} and R is the net resistance seen the by the read-current bus. Similarly, the other vertices are updated in sequence. Each such cycle of state updates, for all vertices, constitutes a time-step.

Algorithms 3-5 provide detailed steps for realizing the proposed heuristics on the system 40 and are set forth in the appendix. The algorithms are suited for sequential code-blocks in a hardware-description language (e.g., Verilog), as these involve reading and asserting real-time signals. All key input and output signals, referenced in Algorithms 3-3, are depicted in FIG. 5. Two key sub-routines are repeatedly used through the algorithms—COMPUTE-ϕ and READ-WRITE, the exact sequence of steps of which is provided in Algorithms 6 and 7.

Algorithm 3 Nodal coupling dynamics (Input: A; Output: v)

1: for ∀{i, j} : A_{i,j} is 1 do
2: Select j for read and i for write
3: Enable global read
4: COMPUTE-ϕ( )
5: READ-WRITE(Analog)
6: end for

Algorithm 4 Randomized rounding (Input: v; Output: σ)

Require: Vertex Y reserved for rounding

| | |
|---|---|
| 1: for k ∈ {1, 2 . . . K} do | [symbol] Each rounding center |
| 2: Select Y for read | |
| 3: for i ∈ {1, 2 . . . N} do | [symbol] Each vertex |
| 4: Select i for write | |
| 5: Π_{R} ← 1 | [symbol] Enable global read |
| 6: COMPUTE-ϕ( ) | |
| 7: READ-WRITE(Binary) | [symbol] Binary write |
| 8: end for | |
| 9: Evaluate cut | [symbol] See Algorithm 6 |

$10 : {n}_{DAC} ← U ( 0 , \frac{P}{K} ) Random positive increment$

| | |
|---|---|
| 11: Select Y for write | [symbol] Rounding-center update |
| 12: READ-WRITE(Analog) | |
| 13: end for | |

Algorithm 5 Cut-evaluation (Input: σ, A; Output: C)

| 1: | for k ∈ {1, 2...K} do | |
|---|---|---|
| 2: | Select n_{C0} + k-th vertex for write | [symbol] Index for storing cut |
| 3: | for i ∈ {1, 2...N} do | |
| 4: | Select i vertex for read | |
| 5: | Enable global binary read | |
| 6: | if C+/− is 1 then | |
| 7: | Invert sign of the following reads | |
| 8: | end if | |
| 9: | for c ∈ 1, 2...C do | [symbol] Iterate over columns |
| 10: | L ← { } | [symbol] List of vertices simultaneously read |
| 11: | for r ∈ 1, 2...R do | [symbol] Iterate over rows |
| 12: | j ← index of vertex at (r, c) | |
| 13: | if Aᵢⱼ is 1 && i < j then | |
| 14: | Push j to L | |
| 15: | end if | |
| 16: | end for | |
| 17: | Select all vertices in L for read | |
| 18: | READ-WRITE(Analog) | |
| 19: | end for | |
| 20: | end for | |
| 21: | if k > 1 then | |
| 22: | Select vertices k and kₘₐₓ for read | |
| 23: | Enable global read | |
| 24: | if C+/− is 1 then | |
| 25: | kₘₐₓ ← k | [symbol] Max. cut index swapping |

| | |
|---|---|
| 26: | end if |
| 27: | Disable all read/write |
| 28: | end if |
| 29: | end for |

Algorithm 6 Key sub-routine COMPUTE-ϕ

| Require: Vertices enabled for reading and writing | | |
|---|---|---|
| 1: | procedure COMPUTE-ϕ | |
| 2: | C₁ ← 0 | |
| 3: | C₂ ← 0 | |
| 4: | n_{DAC} ← 1 | |
| 5: | while C₁ is C₂ do | |
| 6: | C₁ ← C_{+/-} | [symbol] Read comparator |

| | |
|---|---|
| 7: | n_{DAC} ← nDAC + 2C₁ |
| 8: | C₂ ← C_{+/-} |
| 9: | end while |
| 10: | n_{DAC} ← n_{DAC} + C₂ |
| 11: | if mod(n_{DAC}, 4) is 0 then |
| 12: | S ← 1 |
| 13: | else |
| 14: | S ← 0 |
| 15: | end if |
| 16: | end procedure |

Algorithm 7 Key sub-routine READ-WRITE

| | |
|---|---|
| 1: | procedure READ-WRITE(mode = {Binary, Analog} |
| 2: | Toggle Π_{R} |
| 5: | if mode is Analog then |
| 6: | Enable global write |
| 9: | else |
| 10: | Enable binary write |
| 11: | end |
| 12: | Toggle Π_{W} |
| 14: | Disable all read/writes |
| 16: | end procedure |

The algorithm for the nodal coupling dynamics is provided in Algorithm 3. The execution time for the nodal coupling dynamics scales as O(M), where M is the number of edges. Though a vertex-stationary array realizes the dynamics of equation (12), a shared bus restricts the number of state updates in a given period of time, as only one edge is processed at a time.

Detailed algorithms for binarization with K rounding centers and cute evaluation are provided in Algorithms 4 and 5, respectively

The vertex is primarily a capacitor-based analog memory with a differential gm-cell that converts the capacitor's voltage to a proportional current as the output of a read. Additionally, the vertex has a 2:2 multiplexer to invert the sign of the current, and a minimal logic to select itself for read/write. FIG. 6 depicts the block diagram of the proposed vertex, with the capacitor C, and the other components accordingly labelled.

The analog memory is implemented using metal-insulator-metal (MIM) capacitor. This allows one to place the capacitor above the substrate containing the actual transistors, thus saving area. The capacitor's minimum allowed size depends on (1) ability to undergo writing cycles without losing substantial existing charge, and (2) the size of the CMOS components below, which it should not significantly exceed. To set the common mode of the state voltages to a pre-determined value, we split the capacitor in a series of two identical C_{P} and C_{N} and assert their common node during every read-cycle.

The g_{M}-cell (FIGS. 6 and 7) converts the capacitor's analog charge to a proportional current. A differential amplifier with a tail current-source ensures that the transconductance is largely independent of input common-mode voltage.

All the analog switches of the cell are implemented using transmission gates. The design requires that all the bus voltages be between 0 and the V_{DD}, even when writing. Read-enable switches turn on the gm-cell's current output to the current bus. Write-enable switches enable charge from the write bus to pass through. A 2:2 multiplexer serves as an output sign-selection switch for inverting the output differential current.

A minimally sized logic determines the following local signals from the global row and column signals: (1) select-enable of the vertex, (2) g_{M}-cell's one-bit weight, (3) sign of the output current, and (4) binary spin-state.

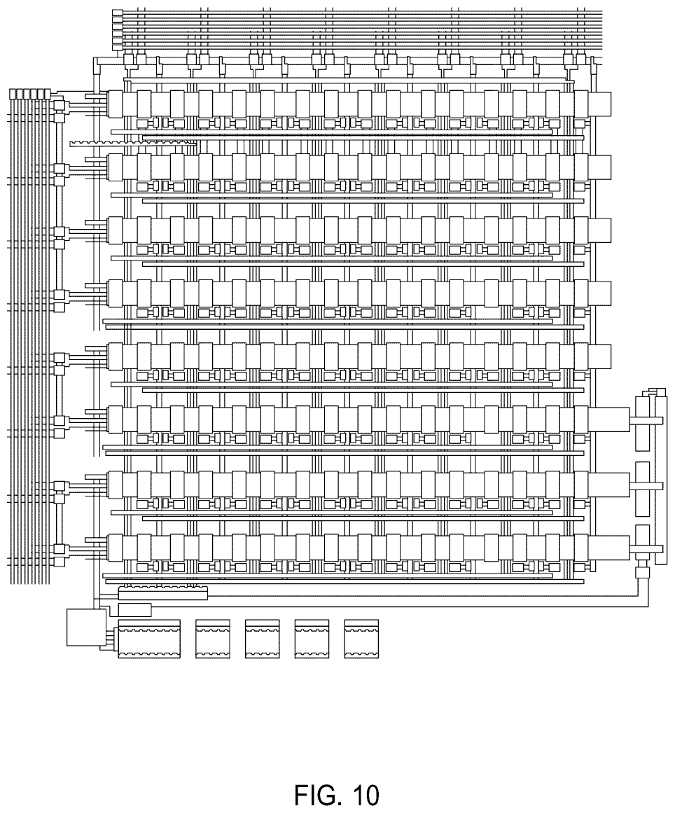

The read-write amplifier buffers the net read-bus voltage onto the buffer capacitor C_{B} and pushes the charge thus stored to the updated vertex. This block may be divided into two components: read-buffer and write-buffer (FIG. 10). The read-buffer is a differential amplifier with a current-mirror load and has a small but linear gain. Extra sinking loads are used for operating point's adjustment, setting it closer to V_{DD}/2. Capacitor C_{B} stores the read-bus voltage and supplies its charge to the capacitor of the vertex being written onto. Since the peak increment in the state is generally smaller than the maximum state voltage, the capacitance C_{B} is smaller than C_{P} and C_{N}. For this reason, lower metals layers are used for C_{B}.

The write-stage is essentially a high gain amplifier with differential input and single-ended output (FIGS. 6 and 10). Its primary gain stage is a current-mirror loaded differential amplifier. One can design its gain to be large enough so that the amplifier can push charges reliably over the long write-bus, but not so much as to cause any oscillatory side-reaction due to positive feedback. Its secondary/output stage is an inverting amplifier with resistive load to limit the gain, provide high voltage swing, and predictably set the output operating point. Ideally, the charge increments provided by write-stage must be homogeneous with respect to the read-bus voltage and must cause zero increments for zero inputs. This trend may be easily disrupted post-fabrication due to the single-endedness of its input (the voltage across C_{B}). To limit any such non-homogeneity, the amplifier output is balanced with respect to the input. This is done using a three-step process once during the entire IC's operation. First, remove any differential input to the read bus, or effectively ensuring V_{i,N}=V_{i,P} (FIG. 10). Then, store the voltage across C_{B} onto C′ by asserting binary signal Πₒ. Lastly, all the vertex capacitors (C) are simultaneously preset to the output of the write stage, V_{o,N}−V_{o,P}.

The DAC plays a critical role in the realization of the heuristics by digitally stepping up/down the read-bus current. It is used in modulo and ϕ realization, random initialization of vertices and incrementally shifting the rounding center during binarization. In one example, a 5-bit DAC is used, which provides enough separation between the zeroes assuming a full (0 to V_{DD}) input range for ϕ. To implement DAC, the gm-cell of the vertex is reused with the multiplicities 1,2,4,8 and 16. This allows a direct control over the zeros of ϕ, e.g., if the first zero is to be placed at 0.1 V, one could set the input to the DAC's g_{M} cell to 0.1 V. By tuning the input voltage of the g_{M}-cell, one may also scale the current-step of the DAC and alter the number of bits.

The comparator was implemented using a 5-stage high gain differential amplifier, with an absolute voltage gain of about 1000. Thus, it could compare small but frequently occurring differential voltages of 1 mV. Read-bus pinning circuit, pins the common mode read-bus voltage to V_{DD}/2. It uses the principle of common-mode feedback, i.e., it feeds back current into the bus depending on the separation from its desired value of V_{DD}/2. Lastly, the sign-inverter is essentially a 2:2 multiplexer.

The presented computing device is designed to accommodate a fully connected graphs and can be directly employed for a more general class of problems. Some graph topologies, such as the planar, are relatively easily accelerated using alternative Ising machines. Many area-efficient accelerators have been proposed that support planar spin lattices. However, assuming planarity of problems limits the applicability of the machine and requires embedding methods that increase the effective number of nodes.

Many problems of practical importance demand weights to possess multiple bits. This can be achieved by modulating the capacitance that sends back the charge to the state capacitor (C_{B}). For multi-bits of weights, the charge increments can be scaled up by using larger C_{B}.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hybrid analog-digital architecture, comprising:
an adjacency memory configured to store a graph representing an optimization problem;
an array of memory cells arranged in columns and rows, each node of the graph is assigned to a memory cell in the array of memory cells and each memory cell is configured to store an electric charge representing a spin state of an Ising model;
a computing circuit interfaced with the array of memory cells, wherein the computing circuit is configured to read current from a given pair of memory cells in the array of memory cells, compute a differential current between the currents read from the given pair of memory cells, compute an update charge for one of the memory cells in the given pair of memory cells using the differential current, and transfer the update charge to the one memory cell in the given pair of memory cells; and
a global controller interconnected between the adjacency memory and the array of memory cells, wherein the global controller operates to select the given pair of memory cells in the array of memory cells in accordance with the graph and coordinate an update to one of the memory cells in the given pair of memory cells using the computing circuit.

2. The hybrid analog-digital architecture of claim 1 wherein each memory cell in the array of memory cells stores the electric charge on a capacitor.

3. The hybrid analog-digital architecture of claim 1 wherein each memory cell in the array of memory cells is comprised of a transconductance cell and a current inverter.

4. The hybrid analog-digital architecture of claim 1 wherein the global controller is configured to initialize spin states of the memory cells in the array of memory cells.

5. The hybrid analog-digital architecture of claim 1 wherein the global controller iteratively updates the electric charge stored in each memory cell of the array of memory cells until a stopping condition is met.

6. The hybrid analog-digital architecture of claim 5 wherein the global controller iteratively updates the electric charge for a given memory cell by identifying nodes adjacent to a given node in the graph; for node adjacent to the given node, determining a contribution to the given node by the adjacent node;
accumulating the contributions for the given node; and updating the electric charge for the given memory cell with the accumulated contribution, where the given node is assigned to the given memory cell.

7. The hybrid analog-digital architecture of claim 6 further comprises determining a contribution to the given node according to a piece-wise linear periodic function.

8. The hybrid analog-digital architecture of claim 6 further comprises determining a contribution to the given node in proportion with the coupling function
$$ϕ ( Δ v ) = \{ \begin{matrix}- Δ v , & Δ v ∈ ( - \frac{P}{4} , \frac{P}{4} ] \\ Δ v - \frac{P}{2} , & Δ v ∈ ( \frac{P}{4} , \frac{3 P}{4} ]\end{matrix}$$
where Δν is difference between stored voltages on capacitors of a pair of memory cells and P is a predetermined circuit parameter.

9. The hybrid analog-digital architecture of claim 5 wherein, for each memory cell in the array of memory cells and after meeting the stopping condition, the global controller compares the electric charge stored by a particular memory cell to a referential charge v_{y} stored in a designated memory cell and evaluates the sign of a coupling function ϕ for the difference between the charges, the obtained value, +1 or −1, is taken as the rounded value of the charge in the particular cell.

10. A method for solving an optimization problem, comprising:
constructing a problem graph for an optimization problem, where the node of the problem graph represent variables in the optimization problem;
mapping nodes of the problem graph to spin states of an Ising model;
assigning each spin state of the Ising model to a memory cell in an array of memory cells, where each memory cell is configured to store an electric charge representing the spin state; and
determining a minimum energy state for the array or memory cells in accordance with the problem graph.

11. The method of claim 10 further comprises randomly initializing spin states of the Ising model stored in the array of memory cells.

12. The method of claim 10 further comprises determining a minimum energy state by iteratively updating the electric charge stored in the array of memory cells.
